(19) United States
(12) Patent Application Publication
(10) Pub. No.: US 2025/0253328 A1
(43) Pub. Date: Aug. 7, 2025

(54) ELECTRODE MIXTURE SLURRY FOR SOLID-STATE BATTERY AND METHOD FOR PRODUCING ELECTRODE MIXTURE SLURRY

(71) Applicants: TOYOTA JIDOSHA KABUSHIKI KAISHA, Aichi-ken (JP); Panasonic Holdings Corporation, Osaka (JP)

(72) Inventors: Masahiro IWASAKI, Nagoya-shi (JP); Yasutaka TSUTSUI, Osaka-shi (JP)

(21) Appl. No.: 19/043,110

(22) Filed: Jan. 31, 2025

(30) Foreign Application Priority Data
Feb. 1, 2024 (JP) 2024-014206
Jan. 23, 2025 (JP) 2025-010090

(51) Int. Cl. H01M 4/58; H01M 4/02; H01M 4/62; H01M 10/0562

(52) U.S. Cl. CPC H01M 4/5825; H01M 4/622; H01M 10/0562; H01M 2004/021; H01M 2004/027

(57) ABSTRACT

It is an object of the present disclosure to provide an electrode mixture slurry for a solid-state battery with reduced gelling. An electrode mixture slurry for a solid-state battery, the electrode mixture slurry comprising an electrode active material, a solid electrolyte, a conductive aid, a binder and a dispersing agent, wherein A₁ (A₁=B/C1) is 700 or greater, A₂ (A₂=B/C₂) is 2000 or greater, the storage modulus of the electrode mixture slurry being smaller than the loss modulus of the electrode mixture slurry throughout the entire shear strain range of 0.01% to 1000%.

### FIELD

The present disclosure relates to an electrode mixture slurry for a solid-state battery and to a method for producing an electrode mixture slurry.

### BACKGROUND

An electrode mixture slurry used for a solid-state battery is a slurry comprising an electrode active material or a solid electrolyte, the electrode active material layer being formed by coating the surface of a substrate with an electrode mixture slurry and drying it, if necessary with pressing. The following slurries with improved dispersibility are known.

PTL 1, for example, discloses a slurry comprising a solvent, silicon particles, a solid electrolyte and a dispersing agent, the solvent containing a low polar solvent having a Hansen solubility parameter polar term 8P of 4 or lower, the dispersing agent comprising a first dispersing agent with a basic functional group, and the silicon particles having a peak in the range of 1600±10 cm⁻¹ and in the range of 1400±10 cm⁻¹ in the FT-IR spectrum after pyridine adsorption. The slurry of PTL 1 is described as having improved dispersibility.

### CITATION LIST

### Patent Literature

[PTL 1] Japanese Unexamined Patent Publication No. 2023-103642

### SUMMARY

### Technical Problem

An electrode mixture slurry is a solid-dispersed slurry having an electrode active material, a solid electrolyte and a conductive aid, with the dispersed state of the solids being stabilized by the presence of a binder or dispersing agent. The performance of the electrode active material layer depends mainly on the solid composition of the electrode mixture slurry, with flocculation tending to occur in the electrode mixture slurry depending on the solid composition of the electrode mixture slurry, and thus tending to result in gelling of the electrode mixture slurry. The problem of gelling is particularly prominent with a large surface area of the solid with respect to the binder or dispersing agent content in the electrode mixture slurry.

It is an object of the present disclosure to provide an electrode mixture slurry for a solid-state battery with reduced gelling.

### Solution to Problem

The present disclosure achieves the object described above by the following means.

### <Aspect 1>

An electrode mixture slurry for a solid-state battery,
the electrode mixture slurry comprising an electrode active material, a solid electrolyte, a conductive aid, a binder and a dispersing agent, wherein
A₁ represented in the following Formula 1 is 700 or greater:

$${A}_{1} = B / C 1 : \qquad Formula 1$$

B: total surface area of electrode active material, solid electrolyte and conductive aid in 1 g of electrode mixture slurry, in units of m²,
C₁: content ratio of binder with respect to 1 part by mass of electrode mixture slurry, in units of parts by mass, and
A₂ represented in the following Formula 2 is 2000 or greater:

$${A}_{2} = B / {C}_{2} : \qquad Formula 2$$

B: total surface area of electrode active material, solid electrolyte and conductive aid in 1 g of electrode mixture slurry, in units of m²,
C₂: content ratio of dispersing agent with respect to 1 part by mass of electrode mixture slurry, in units of parts by mass,
the storage modulus of the electrode mixture slurry being smaller than the loss modulus of the electrode mixture slurry throughout the entire shear strain range of 0.01% to 1000%.

### <Aspect 2>

The electrode mixture slurry according to aspect 1, wherein the electrode active material is a negative electrode active material.

### <Aspect 3>

A method for producing an electrode mixture slurry according to aspect 1 or 2, the method comprising the following steps:
providing a preliminary electrode mixture slurry comprising the electrode active material, the solid electrolyte, the conductive aid, the binder and the dispersing agent, and
applying distributed energy of 3.0×10° J/L or lower to the preliminary electrode mixture slurry to stir the preliminary electrode mixture slurry, thereby preparing the electrode mixture slurry.

### Advantageous Effects of Invention

The electrode mixture slurry for a solid-state battery of the disclosure can reduce gelling.

### BRIEF DESCRIPTION OF DRAWINGS

FIG. 1 shows the storage modulus and loss modulus of the electrode mixture slurry S1 of Example 1, with shear strain in the range of 0.01% to 1000%.

FIG. 2 shows the storage modulus and loss modulus of the electrode mixture slurry s1 of Comparative Example 1, with shear strain in the range of 0.01% to 1000%.

### DESCRIPTION OF EMBODIMENTS

Embodiments of the disclosure will now be explained in detail. The present disclosure is not limited to the embodiments described below, however, and various modifications may be implemented which do not depart from the gist thereof. Similar elements in the drawings are indicated by like reference numerals and will be explained only once.

For the purpose of the disclosure, “mixture” means a composition that can form an electrode active material layer either by itself or by further comprising other components. Moreover, the term “mixture slurry” means a slurry that includes a dispersing medium in addition to the “mixture”, allowing it to form an electrode active material layer by being coated and dried.

The term “solid-state battery” as used herein refers to a battery using at least a solid electrolyte as the electrolyte, and the solid-state battery may also employ a combination of a solid electrolyte and a liquid electrolyte as the electrolyte. Alternatively, the solid-state battery of the disclosure may be an all-solid-state battery, i.e. a battery employing only a solid electrolyte as the electrolyte.

### <Electrode Mixture Slurry>

In the electrode mixture slurry for a solid-state battery of the disclosure:
the electrode mixture slurry comprises an electrode active material, a solid electrolyte, a conductive aid, a binder and a dispersing agent, wherein
A1 represented in the following Formula 1 is 700 or greater:

$${A}_{1} = B / C 1 : \qquad Formula 1$$

B: total surface area of electrode active material, solid electrolyte and conductive aid in 1 g of electrode mixture slurry, in units of m²,
C₁: content ratio of binder with respect to 1 part by mass of electrode mixture slurry, in units of parts by mass, and
A₂ represented in the following Formula 2 is 2000 or greater:

$${A}_{2} = B / {C}_{2} : \qquad Formula 2$$

B: total surface area of electrode active material, solid electrolyte and conductive aid in 1 g of electrode mixture slurry, in units of m²,
C₂: content ratio of dispersing agent with respect to 1 part by mass of electrode mixture slurry, in units of parts by mass,
the storage modulus of the electrode mixture slurry being smaller than the loss modulus of the electrode mixture slurry throughout the entire shear strain range of 0.01% to 1000%.

The electrode mixture slurry for a solid-state battery of the disclosure can reduce gelling.

Without being limited to theory, it is conjectured that for an electrode mixture slurry in which flocculation is easily generated, i.e. an electrode mixture slurry with a large percentage of surface area of solid components such as the electrode active material with respect to the binder and dispersing agent, and more concretely for an electrode mixture slurry wherein A₁ as defined above is 700 or greater and A₂ as defined above is 2000 or greater, if the storage modulus of the electrode mixture slurry is smaller than the loss modulus throughout the entire shear strain range of 0.01% to 1000%, then the electrode mixture slurry maintains its liquid property, thus helping to reduce gelling of the electrode mixture slurry, even when shear force is applied to the electrode mixture slurry during transport, for example. On the other hand, it is conjectured that if the storage modulus of the electrode mixture slurry is smaller than the loss modulus in at least part of the shear strain range of 0.01% to 1000%, then when the electrode mixture slurry is subjected to shear force by transport, for example, the force acting on the electrode mixture slurry causes the electrode mixture slurry to exhibit a solid property, thus producing gelling of the electrode mixture slurry.

### <Construction of Electrode Mixture Slurry for Solid-State Battery>

The electrode mixture slurry for a solid-state battery of the disclosure comprises an electrode active material, solid electrolyte, conductive aid, binder and dispersing agent. The electrode mixture slurry may also comprise a dispersing medium, although this is not particularly restrictive.

According to the disclosure, the storage modulus of the electrode mixture slurry is smaller than the loss modulus of the electrode mixture slurry throughout the entire shear strain range of 0.01% to 1000%.

The storage modulus and loss modulus of the electrode mixture slurry can be measured by changing the shear strain in a range of 0.01% to 1000% at a constant frequency, using a rheometer. The rheometer used for measurement may be an Anton Paar GmbH MCR302, for example.

The storage modulus of the electrode mixture slurry is not particularly restricted so long as it is smaller than the loss modulus of the electrode mixture slurry. The storage modulus of the electrode mixture slurry throughout the entire shear strain range of 0.01% to 1000% is not particularly restricted and may be 0.1 MPa or higher, 0.5 MPa or higher, 1.0 MPa or higher, 1.5 MPa or higher or 2.0 MPa or higher, and 10 MPa or lower, 5.0 MPa or lower, 4.0 MPa, 3.5 MPa, 3.0 MPa, 2.5 MPa or lower or 2.0 MPa or lower.

The loss modulus of the electrode mixture slurry is not particularly restricted so long as it is larger than the storage modulus of the electrode mixture slurry. The loss modulus of the electrode mixture slurry throughout the entire shear strain range of 0.01% to 1000% is not particularly restricted and may be 0.1 MPa or higher, 0.5 MPa or higher, 1.0 MPa or higher, 1.5 MPa or higher or 2.0 MPa or higher, and 10 MPa or lower, 5.0 MPa or lower, 4.0 MPa, 3.5 MPa, 3.0 MPa, 2.5 MPa or lower or 2.0 MPa or lower.

The ratio of the loss modulus with respect to the storage modulus of the electrode mixture slurry (loss modulus/storage modulus), i.e. the loss tangent (tan δ), throughout the entire shear strain range of 0.01% to 1000%, may be 1.0 or higher, 1.2 or higher, 1.4 or higher, 1.6 or higher, 1.8 or higher or 2.0 or higher, and 50 or lower, 40 or lower, 30 or lower or 20 or lower.

The difference between the storage modulus and the loss modulus of the electrode mixture slurry (loss modulus-storage modulus) through the entire shear strain range of 0.01% to 1000% is not particularly restricted, and may be 0.01 MPa or greater, 0.1 MPa or greater, 0.5 MPa or greater or 1.0 MPa or greater, and 10 MPa or less, 5.0 MPa or less, 2.0 MPa or less or 1.0 MPa or less.

The percentage of the solid mass with respect to the mass of the electrode mixture slurry of the disclosure, i.e. the solid concentration of the electrode mixture slurry, is not particularly restricted and may be 40 mass % or greater, 50 mass % or greater, 60 mass % or greater, 70 mass % or greater or 80 mass % or greater, and 100 mass % or lower, 90 mass % or lower or 80 mass % or lower.

### <Electrode Active Material>

The electrode active material may be a positive electrode active material or a negative electrode active material. The electrode active material is not particularly restricted but is preferably a negative electrode active material.

### (Positive Electrode Active Material)

The material for the positive electrode active material is not particularly restricted and may be one that is capable of occluding and releasing lithium ions. Examples of positive electrode active materials include, but are not limited to, lithium cobaltate (LiCoO₂), lithium nickelate (LiNiO₂), lithium manganate (LiMn₂O₄), nickel-cobalt-lithium manganate (NCM: LiCO_{1/3}Ni_{1/3}Mn_{1/3}O₂), nickel-cobalt-lithium aluminate (LiNi_{0.8}(CoAl)_{0.2}O₂) and Li—Mn spinel substituted with different elements, having the composition represented by Li₁₊ₓMn_{2-x-y}M_{y}O₄ (where M is one or more metal elements selected from among Al, Mg, Co, Fe, Ni and Zn).

The positive electrode active material is not particularly restricted, and it may have a covering layer. The covering layer is a layer comprising a substance that exhibits lithium ion conductivity, has low reactivity with the positive electrode active material or solid electrolyte, and can maintain the shape of the covering layer without flowing even when contacting the active material or solid electrolyte. Specific examples of materials to form the covering layer include, but are not limited to, LiNbO₃, as well as Li₄Ti₅O₁₂, Li₃PO₄ and Li—Ti—Al—F-based materials.

The form of the positive electrode active material may be any common form used as a positive electrode active material for a solid-state battery, without any particular restrictions. The positive electrode active material may be particulate, for example. The positive electrode active material may be primary particles, or secondary particles which are aggregates of multiple primary particles. The specific surface area of the positive electrode active material is not particularly restricted and may be 0.5 m²/g or greater, 1.0 m²/g or greater, 2.0 m²/g or greater, 3.0 m²/g or greater or 3.5 m²/g or greater, and 10 m²/g or lower, 8.0 m²/g or lower, 6.0 m²/g or lower or 4.0 m²/g or lower. The specific surface area of the positive electrode active material can be measured by the BET method using nitrogen as the adsorbate.

### (Negative Electrode Active Material)

The negative electrode active material used may be any of various substances whose potential for storing and releasing lithium ions (charge-discharge potential) is electronegative potential compared to the positive electrode active material of the disclosure. The material for the negative electrode active material is not particularly restricted, and it may be lithium metal, or any material capable of occluding and releasing metal ions such as lithium ions. Examples of materials capable of occluding and releasing metal ions such as lithium ions include, but are not limited to, alloy-based negative electrode active materials and carbon materials, or lithium titanate (Li₄Ti₅O₁₂).

Alloy-based negative electrode active materials are not particularly restricted, and examples include Si alloy-based negative electrode active materials and Sn alloy-based negative electrode active materials. Si alloy-based negative electrode active materials include silicon, silicon oxides, silicon carbides, silicon nitrides, and their solid solutions. A Si alloy-based negative electrode active material may also include metal elements other than silicon, such as Fe, Co, Sb, Bi, Pb, Ni, Cu, Zn, Ge, In, Sn and Ti, for example. Sn alloy-based negative electrode active materials include tin, tin oxides, tin nitrides, and their solid solutions. A Sn alloy-based negative electrode active material may also include metal elements other than tin, such as Fe, Co, Sb, Bi, Pb, Ni, Cu, Zn, Ge, In, Ti and Si, for example.

Carbon materials are not particularly restricted and include hard carbon, soft carbon and graphite, for example.

The form of the negative electrode active material may be any common form used as a negative electrode active material for a solid-state battery, without any particular restrictions. The negative electrode active material may be particulate, for example. The negative electrode active material may be primary particles, or secondary particles which are aggregates of multiple primary particles. The specific surface area of the negative electrode active material is not particularly restricted and may be 0.5 m²/g or greater, 1.0 m²/g or greater, 2.0 m²/g or greater, 3.0 m²/g or greater or 3.5 m²/g or greater, and 10 m²/g or lower, 8.0 m²/g or lower, 6.0 m²/g or lower or 4.0 m²/g or lower. The specific surface area of the negative electrode active material can be measured by the BET method using nitrogen as the adsorbate.

### <Solid Electrolyte>

The material of the solid electrolyte may be a sulfide solid electrolyte, an oxide solid electrolyte or a polymer electrolyte, for example, although this is not limitative.

Examples of sulfide solid electrolytes include, but are not limited to, sulfide-based amorphous solid electrolytes, sulfide-based crystalline solid electrolytes and argyrodite solid electrolytes. Specific examples of sulfide solid electrolytes include, but are not limited to, Li₂S—P₂S₅ (such as Li₇P₃S₁₁, Li₃PS₄ and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃S₁₆ and Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄ and Li₃₊ₓPO₄₋ₓNₓ(LiPON).

The sulfide solid electrolyte and oxide solid electrolyte may be glass or crystallized glass (glass ceramic).

Polymer electrolytes include, but are not limited to, polyethylene oxide (PEO) and polypropylene oxide (PPO), and their copolymers.

The form of the solid electrolyte may be any common form used as a solid electrolyte for a solid-state battery, without any particular restrictions. The solid electrolyte may be particulate, for example. The solid electrolyte may be primary particles, or secondary particles which are aggregates of multiple primary particles. The specific surface area of the solid electrolyte is not particularly restricted and may be 1.0 m²/g or greater, 2.0 m²/g or greater, 4.0 m²/g or greater, 6.0 m²/g or greater or 8.0 m²/g or greater, and 15 m²/g or lower, 13 m²/g or lower, 11 m²/g or lower or 9.0 m²/g or lower. The specific surface area of the solid electrolyte can be measured by the BET method using nitrogen as the adsorbate.

### <Conductive Aid>

The conductive aid is not particularly restricted. The conductive aid may be, but is not limited to, vapor-deposited carbon fiber (VGCF), acetylene black (AB), Ketjen black (KB), carbon nanotubes (CNT), carbon nanofibers (CNF) or conductive carbon. The conductive aid is not particularly restricted and may be of a single type alone, or two or more different types may be used in combination.

The conductive aid may be particulate or filamentous, for example, and its size is not particularly restricted. The specific surface area of the conductive aid is not particularly restricted and may be 4.0 m²/g or greater, 6.0 m²/g or greater, 8.0 m²/g or greater, 10 m²/g or greater or 12 m²/g or greater, and 20 m²/g or lower, 18 m²/g or lower, 16 m²/g or lower or 14 m²/g or lower. The specific surface area of the conductive aid can be measured by the BET method using nitrogen as the adsorbate.

### <Binder>

The binder is also not particularly restricted. Examples for the binder include, but are not limited to, materials such as polyvinylidene fluoride (PVdF), butadiene rubber (BR), polytetrafluoroethylene (PTFE), and styrene-butadiene rubber (SBR). The binder is not particularly restricted and may be of a single type alone, or two or more different types may be used in combination.

The value of A₁ in the electrode mixture slurry for a solid-state battery of the disclosure in Formula 1 is 700 or greater.

$${A}_{1} = B / C 1 : \qquad Formula 1$$

B: Total surface area of electrode active material, solid electrolyte and conductive aid in 1 g of electrode mixture slurry, in units of m².
C₁: Content ratio of binder with respect to 1 part by mass of electrode mixture slurry, in units of parts by mass.

A larger A₁ value for the electrode mixture slurry increases the total surface area of the electrode active material, solid electrolyte and conductive aid in the electrode mixture slurry, or decreases the content of the binder in the electrode mixture, resulting in failure of the binder to stabilize the dispersed state of the electrode active material, solid electrolyte and conductive aid, and thus tending to produce flocculation in the electrode mixture slurry. The value of A₁ for the electrode mixture slurry of the disclosure is not particularly restricted and may be 700 or greater, 720 or greater, 740 or greater, 760 or greater or 780 or greater, and 1000 or lower, 950 or lower, 900 or lower or 850 or lower.
B is the total surface area of the electrode active material, solid electrolyte and conductive aid in 1 g of electrode mixture slurry, in units of m². When two or more electrode active materials are used, the surface area of the electrode active material represents their total amount. The same applies for the solid electrolyte and conductive aid. The surface area can be determined by multiplying the specific surface area (m²/g) by the content (g) of each component. The specific surface area can be measured by the BET method using nitrogen as the adsorbate. The value of B for the electrode mixture slurry of the disclosure is not particularly restricted and may be 1.0 or greater, 1.5 or greater, 2.0 or greater, 2.5 or greater or 3.0 or greater, and 10 or lower, 8.0 or lower, 6.0 or lower or 4.0 or lower.
C₁ is the content ratio of binder with respect to 1 part by mass of electrode mixture slurry, in units of parts by mass. When two or more binders are used, the content of the binder represents their total amount. The value of C₁ for the electrode mixture slurry of the disclosure is not particularly restricted and may be 0.001 or higher, 0.002 or higher, 0.003 or higher or 0.004 or higher, and 0.01 or lower, 0.008 or lower, 0.006 or lower or 0.005 or lower.

### <Dispersing Agent>

The dispersing agent is also not particularly restricted. The dispersing agent used may be, but is not limited to, a high molecular weight alkylolaminoamide compound. The dispersing agent is not particularly restricted and may be of a single type alone, or two or more different types may be used in combination.

The value of A₂ in the electrode mixture slurry for a solid-state battery of the disclosure in Formula 2 is 2000 or greater.

$${A}_{2} = B / {C}_{2} : \qquad Formula 2$$

B: Total surface area of electrode active material, solid electrolyte and conductive aid in 1 g of electrode mixture slurry, in units of m².
C₂: Content ratio of dispersing agent with respect to 1 part by mass of electrode mixture slurry, in units of parts by mass.

A larger A₂ value for the electrode mixture slurry increases the total surface area of the electrode active material, solid electrolyte and conductive aid in the electrode mixture slurry, or decreases the content of the dispersing agent in the electrode mixture, resulting in failure of the dispersing agent to stabilize the dispersed state of the electrode active material, solid electrolyte and conductive aid, and thus tending to produce flocculation in the electrode mixture slurry. The value of A₂ for the electrode mixture slurry of the disclosure is not particularly restricted and may be 2000 or greater, 2050 or greater, 2100 or greater, 2150 or greater or 2200 or greater, and 3000 or lower, 2800 or lower, 2600 or lower or 2400 or lower.

C₂ is the content ratio of dispersing agent with respect to 1 part by mass of electrode mixture slurry, in units of parts by mass. When two or more dispersing agents are used, the content of the dispersing agent represents their total amount. The value of C₂ for the electrode mixture slurry of the disclosure is not particularly restricted and may be 0.0001 or greater, 0.0005 or greater, 0.0008 or greater, 0.0011 or greater or 0.0014 or greater, and 0.0040 or lower, 0.0030 or lower, 0.0020 or lower or 0.0015 or lower.

The value of B may be selected with reference to the description under the heading “<Binder>” above.

### <Dispersing Medium>

The dispersing medium is also not particularly restricted. Examples of dispersing media include, but are not limited to, tetralin (1,2,3,4-tetrahydronaphthalene), anisole, xylene, octane, hexane, decalin, butyl acetate, ethyl propionate, tripropylamine, N-methyl-2-pyrrolidone (NMP) and water. The dispersing medium is not particularly restricted but may be of a single type alone, or two or more different types may be used in combination.

The value of A₁ and A₂ in the electrode mixture slurry can be determined in the following manner. The electrode mixture slurry is separated into the active material, solid electrolyte and conductive aid, as the solid components and the binder, dispersing agent and solvent, as the solution components, using a centrifugal separator. The contents and types of solid components are identified by ICP. The content of each solution component is then determined by TG-DTA, and the material type of each component is identified by FT-IR. This allows calculation of the proportion of the electrode active material, solid electrolyte, conductive aid, binder and dispersing agent in 1 g of the electrode mixture slurry. B, C₁ and C₂ are calculated, and A₁ and A₂ are determined, using the total surface area and the specific surface area of each substance, in units of m². The value for the specific surface area of each substance may be a value found in the literature, or when the published value is not appropriate, the specific surface area may be confirmed by the BET method.

If the storage modulus of the electrode mixture slurry is smaller than the loss modulus of the electrode mixture slurry throughout the entire shear strain range of 0.01% to 1000%, it can be judged by measuring the strain of the electrode mixture slurry in the range of 0.01% to 1000% using a rheometer under conditions with a frequency of 1 Hz, and confirming the storage modulus G′ and loss modulus G″ at that time.

### <Method for Producing Electrode Mixture Slurry>

The electrode mixture slurry for a solid-state battery of the disclosure can be produced by a production method comprising the following steps.

Providing a preliminary electrode mixture slurry comprising an electrode active material, solid electrolyte, conductive aid, binder and dispersing agent, and
applying distributed energy of 3.0×10° J/L or lower to the preliminary electrode mixture slurry to stir the preliminary electrode mixture slurry, thereby preparing an electrode mixture slurry.

With the method for producing an electrode mixture slurry of the disclosure it is possible to produce an electrode mixture slurry of the disclosure with reduced gelling.

Without being limited to theory, presumably limiting the distributed energy to 3.0×10⁶ J/L or lower during production of the electrode mixture slurry reduces overdispersion of the electrode mixture slurry, thereby allowing production of the electrode mixture slurry of the disclosure wherein the storage modulus of the electrode mixture slurry is smaller than the loss modulus throughout the entire shear strain range of 0.01% to 1000%, i.e. an electrode mixture slurry with reduced gelling.

### <Providing Preliminary Electrode Mixture Slurry>

The method of providing the preliminary electrode mixture slurry is not particularly restricted. The method of providing the preliminary electrode mixture slurry may be introduction and mixing of the electrode active material, solid electrolyte, conductive aid, binder and dispersing medium in a specified container, or obtaining a prepared mixture of the electrode active material, solid electrolyte, conductive aid, binder and dispersing medium.

The electrode active material, solid electrolyte, conductive aid, binder and dispersing medium in the preliminary electrode mixture slurry are as described above under the heading “<Construction of electrode mixture slurry for solid-state battery>”.

### <Application of Distributed Energy to Preliminary Electrode Mixture Slurry>

The distributed energy may be applied using an ultrasonic homogenizer (US600AT by Nippon Seiki Co., Ltd.), although this is not limitative. The distributed energy can be calculated from the output and time when the distributed energy is applied. When an ultrasonic homogenizer (US600AT by Nippon Seiki Co., Ltd.) is used, the output applied to the preliminary electrode mixture slurry is not particularly restricted and may be 150 W or greater, 200 W or greater or 250 W or greater, and 650 W or lower, 600 W or lower or 550 W or lower.

The distributed energy applied to the preliminary electrode mixture slurry is not particularly restricted and may be 1.0×10⁵ J/L or greater, 5.0×10⁵ J/L or greater, 1.0×10⁶ J/L or greater or 2.0×10⁶ J/L or greater, from the viewpoint of producing dispersion, and 3.0×10⁶ J/L or lower, 2.8×10⁶ J/L or lower or 2.6×10⁶ J/L or lower, from the viewpoint of inhibiting overdispersion.

The method of stirring the preliminary electrode mixture slurry is not particularly restricted, and a common method allowing stirring of the electrode mixture slurry may be employed.

### <Solid-State Battery>

The solid-state battery may comprise an electrode active material layer formed from the electrode mixture slurry of the disclosure.

The electrode mixture slurry of the disclosure can be used to produce the electrode active material layer by a publicly known method. For example, the electrode mixture slurry comprising each of the components may be coated onto a substrate and dried to form the electrode active material layer.

The method of forming the solid-state battery is not particularly restricted, and any publicly known method may be employed. The method of forming the solid-state battery may be, but is not limited to, a method in which a positive electrode collector layer, positive electrode active material layer, solid electrolyte layer, negative electrode active material layer, negative electrode collector layer, negative electrode active material layer, solid electrolyte layer, positive electrode active material layer and positive electrode collector layer are disposed in that order, and the laminated stack is sealed to form a solid-state battery. The solid-state battery may be constrained by an external pressure of 5 MPa, for example, without being limitative.

### EXAMPLES

The present disclosure will now be explained in further detail by Examples, with the understanding that the scope of the disclosure is not limited to these Examples.

### Example 1

### <Preparation of Electrode Mixture Slurry S1>

After mixing Li₄Ti₅O₁₂ particles (specific surface area: 3.8 m²/g) as the negative electrode active material (48.57 mass %), Li₂S—P₂S₅-based glass ceramic (specific surface area: 8.7 m²/g) as the solid electrolyte (16.32 mass %), conductive carbon (13 m²/g) as the conductive aid (0.54 mass %), a styrene-butadiene rubber (SBR)-based binder as the binder (0.42 mass %), a high molecular weight alkylolaminoamide compound as the dispersing agent (0.15 mass %) and a suitable amount of tetralin as the dispersing medium (34.00 mass %), the mixture was stirred by application of distributed energy of 2.5×10⁶ J/L with an ultrasonic homogenizer (US600AT by Nippon Seiki Co., Ltd.), to an prepare electrode mixture slurry S1. The distributed energy was calculated from the ultrasonic homogenizer output and time. The electrode mixture slurry S1 did not exhibit gelling even when the electrode mixture slurry S1 was subjected to vibration during transport.

### <A1 Value of Electrode Mixture Slurry S1>

The surface area of the electrode active material, solid electrolyte and conductive aid in 1 g of electrode mixture slurry, in unit of m², was 1.85 m² as the surface area of the electrode active material, 1.42 m² as the surface area of the solid electrolyte and 0.07 m² as the surface area of the conductive aid. Therefore the total surface area of electrode active material, solid electrolyte and conductive aid in the electrode mixture slurry S1 in units of m² was 3.34 m². Since the binder was present at 0.0042 parts by mass with respect to 1 part by mass of the electrode mixture slurry, the A₁ value was 794, thus satisfying an A1 value of 700 or greater.

### <A₂ Value of Electrode Mixture Slurry S1>

As noted above, the total surface area of the electrode active material, solid electrolyte and conductive aid in the electrode mixture slurry S1 in units of m² was 3.34 m². Since the dispersing agent was present at 0.0015 parts by mass with respect to 1 part by mass of the electrode mixture slurry, the A₂ value was 2224, thus satisfying an A₂ value of 2200 or greater.

### <Measurement of Storage Modulus and Loss Modulus of Electrode Mixture Slurry S1>

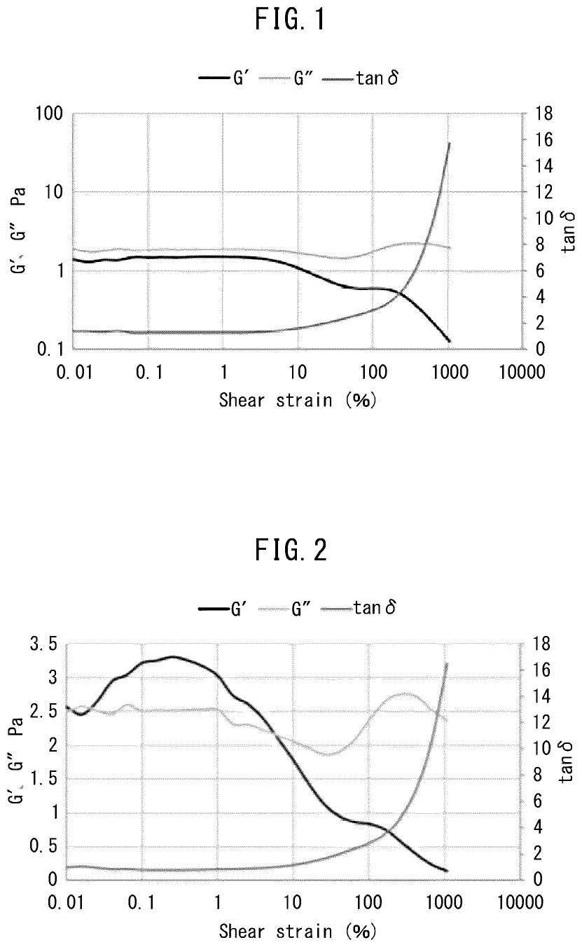

A predetermined amount of the electrode mixture slurry S1 was introduced into a rheometer (MCR302 by Anton Paar GmbH), and the shear strain was varied in the range of 0.01% to 1000% at a constant frequency, measuring the storage modulus and loss modulus during that time. FIG. 1 shows the storage modulus (G′), loss modulus (G″) and loss tangent (tan δ) of the electrode mixture slurry S1 in the shear strain range of 0.01% to 1000%.

### Comparative Example 1

<Preparation of Electrode Mixture Slurry s1>

The electrode mixture slurry s1 was prepared by the same method as Example 1, except that the distributed energy was 3.5×10⁶ J/L. Since the composition of the electrode mixture slurry s1 was the same as the electrode mixture slurry S1, the A₁ and A₂ values of the electrode mixture slurry s1 were also the same as the A₁ and A₂ values of the electrode mixture slurry S1. The electrode mixture slurry s1 exhibited gelling when the electrode mixture slurry s1 was subjected to vibration during transport.

<Measurement of Storage Modulus and Loss Modulus of Electrode Mixture Slurry s1>

The storage modulus and loss modulus of the electrode mixture slurry s1 was measured by the same method as Example 1. FIG. 2 shows the storage modulus (G′), loss modulus (G″) and loss tangent (tan δ) of the electrode mixture slurry s1 in the shear strain range of 0.01% to 1000%.

TABLE 1

| | | Example 1 | Comp. Example 2 |
|---|---|---|---|
| Electrode mixture slurry | | Electrode mixture slurry S1 | Electrode mixture slurry s1 |
| | A₁ (A₁ = B/C₁) | 795 | 795 |
| | A₂ (A₂ = B/C₂) | 2227 | 2227 |
| | Distributed energy [J/L] | 2.5 × 10⁶ | 3.5 × 10⁶ |
| | Storage modulus and loss | Storage modulus smaller than loss | Storage modulus smaller than loss |
| | modulus at shear strain of | modulus throughout entire | modulus in part of measurement |
| | 0.01% to 1000% | measurement range (FIG. 1) | range (FIG. 2) |
| Evaluation | Gelling of electrode | No gelling | Gelling |
| results | mixture slurry | | |

The electrode mixture slurries of Example 1 and Comparative Example 2 were prepared with solid compositions prone to flocculation, i.e. solid compositions in which the A₁ was 700 or greater and the A₂ was 2000 or greater. Despite having the same composition, the electrode mixture slurry S1 wherein the storage modulus was smaller than the loss modulus throughout the entire shear strain range of 0.01% to 1000%, exhibited no gelling, whereas the electrode mixture slurry s1 wherein the storage modulus was smaller than the loss modulus in part of the shear strain range of 0.01% to 1000% did produce gelling.

When the distributed energy applied during production of the electrode mixture slurry was 2.5×10⁶ J/L, the obtained slurry was the electrode mixture slurry S1 wherein the storage modulus was smaller than the loss modulus throughout the entire shear strain range of 0.01% to 1000%. However when the distributed energy applied during production of the electrode mixture slurry was 3.5×10⁶ J/L, the obtained slurry was the electrode mixture slurry s1 wherein the storage modulus was smaller than the loss modulus in part of the shear strain range of 0.01% to 1000%.

For an electrode mixture slurry that is prone to flocculation, i.e. an electrode mixture slurry wherein the A₁ value is 700 or greater and the A₂ value is 2000 or greater, if the storage modulus of the electrode mixture slurry is smaller than the loss modulus throughout the entire shear strain range of 0.01% to 1000%, then the electrode mixture slurry maintains its liquid property, thus helping to reduce gelling of the electrode mixture slurry, even when shear force is applied to the electrode mixture slurry during transport, for example. On the other hand, it is conjectured that if the storage modulus of the electrode mixture slurry is smaller than the loss modulus in at least part of the shear strain range of 0.01% to 1000%, then when the electrode mixture slurry is subjected to shear force by transport, for example, the electrode mixture slurry exhibits a solid property, thus producing gelling of the electrode mixture slurry.

It is conjectured that limiting the distributed energy to 3.0×10⁶ J/L or lower during production of the electrode mixture slurry reduces overdispersion of the electrode mixture slurry, thereby resulting in an electrode mixture slurry wherein the storage modulus of the electrode mixture slurry is smaller than the loss modulus throughout the entire shear strain range of 0.01% to 1000%.

Preferred embodiments of the electrode mixture slurry for a solid-state battery of the disclosure and the method for producing an electrode mixture slurry were described above, but a person skilled in the art will readily appreciate that modifications may be made that do not deviate from the scope of the claims.

1. An electrode mixture slurry for a solid-state battery,
the electrode mixture slurry comprising an electrode active material, a solid electrolyte, a conductive aid, a binder and a dispersing agent, wherein
A₁ represented in the following Formula 1 is 700 or greater:
$${A}_{1} = B / C 1 : \qquad Formula 1$$
B: total surface area of electrode active material, solid electrolyte and conductive aid in 1 g of electrode mixture slurry, in units of m²,
C₁: content ratio of binder with respect to 1 part by mass of electrode mixture slurry, in units of parts by mass, and
A₂ represented in the following Formula 2 is 2000 or greater:
$${A}_{2} = B / {C}_{2} : \qquad Formula 2$$
B: total surface area of electrode active material, solid electrolyte and conductive aid in 1 g of electrode mixture slurry, in units of m²,
C₂: content ratio of dispersing agent with respect to 1 part by mass of electrode mixture slurry, in units of parts by mass,
the storage modulus of the electrode mixture slurry being smaller than the loss modulus of the electrode mixture slurry throughout the entire shear strain range of 0.01% to 1000%.

2. The electrode mixture slurry according to claim 1, wherein the electrode active material is a negative electrode active material.

3. A method for producing an electrode mixture slurry according to claim 1, the method comprising the following steps:
providing a preliminary electrode mixture slurry comprising the electrode active material, the solid electrolyte, the conductive aid, the binder and the dispersing agent, and
applying distributed energy of 3.0×10⁶ J/L or lower to the preliminary electrode mixture slurry to stir the preliminary electrode mixture slurry, thereby preparing the electrode mixture slurry.
